(19) United States
(12) Patent Application Publication
(10) Pub. No.: US 2026/0360805 A1
(43) Pub. Date: Nov. 12, 2026

(54) OXIDE, METHOD FOR PRODUCING SAME, SOLID ELECTROLYTE, AND POWER STORAGE DEVICE

(71) Applicant: TOAGOSEI CO., LTD., Tokyo (JP)

(72) Inventors: Takaaki NATORI, Nagoya-shi, Aichi (JP); Yuhi YAMANO, Nagoya-shi, Aichi (JP); Tomoko NAKANO, Nagoya-shi, Aichi (JP); Naohiko SAITO, Nagoya-shi, Aichi (JP)

(73) Assignee: TOAGOSEI CO., LTD., Tokyo (JP)

(21) Appl. No.: 19/138,058

(22) PCT Filed: Dec. 7, 2023
(86) PCT No.: PCT/JP2023/043840

§ 371 Date: Jun. 11, 2025

(30) Foreign Application Priority Data
Dec. 15, 2022 (JP) 2022-200262

(51) Int. Cl. H01M 10/0562; H01M 10/054

(52) U.S. Cl. CPC H01M 10/0562; H01M 10/054; H01M 2300/0077

(57) ABSTRACT

The present invention provides a novel NASICON-based oxide exhibiting high Na ion conductivity and a method for producing the same. The present invention further provides a solid electrolyte and a power storage device using the oxide. An oxide satisfying the following formula (1). Na_{3+2x+y+α}M1ₓM2_{y}M3_{z}Zr_{2-x-y-z}Si_{2+α}P_{1-α}O₁₂ - - - (1) (in the formula (1), M1 contains an element to be a divalent cation, M2 contains an element to be a trivalent cation containing Al, M3 contains an element (excluding Zr and Si) to be a tetravalent cation, and x, y, z, and a satisfy x≥0, 0<y<0.1, z≥0, and α≥0)

### TECHNICAL FIELD

The present invention relates to an oxide, a method for producing the same, a solid electrolyte, and a power storage device.

### BACKGROUND ART

As a power storage device, various devices such as a secondary battery such as a nickel-metal hydride secondary battery and a lithium ion secondary battery, and an electric double layer capacitor have been put into practical use. Among them, demand for lithium ion batteries (LIB) is expanding because of their high energy density and battery capacity.

The LIB is a secondary battery that has a negative electrode, a positive electrode, and an electrolyte, and performs charge and discharge by moving lithium ions between both the electrodes via the electrolyte. Usually, an organic electrolytic solution obtained by dissolving an electrolyte salt such as LiPF₆ in a carbonate-based solvent is used as the electrolyte, and since a combustible organic solvent is used, there is a possibility of ignition at the time of short circuit.

As a secondary battery capable of solving the above concern, an all-solid-state LIB using a solid electrolyte having Li ion conductivity has been studied, but lithium used in the all-solid-state LIB is concerned about problems such as price increase and depletion of raw materials.

Therefore, an all-solid-state sodium ion battery (NIB) has been studied which uses resource-rich and inexpensive sodium as a substitute for lithium, and performs charging and discharging by movement of sodium ions (For example, Patent Literature 1).

As a solid electrolyte having Na ion conductivity, a sulfide-based solid electrolyte, an oxide-based solid electrolyte, and the like are known.

Among them, the sulfide-based solid electrolyte is unstable in the atmosphere and has a risk of hydrogen sulfide generation, and thus has a problem in safety. On the other hand, the oxide-based solid electrolyte has higher stability in the atmosphere than the sulfide-based solid electrolyte, and is excellent in safety.

As one of the oxide-based solid electrolytes, Na₃Zr₂Si₂PO₁₂ which is NASICON is known, and improvement of ion conductivity by doping with various elements is studied, and for example, in Non-Patent Literature 1, cerium (Ce) is doped.

### CITATION LIST

### Patent Literature

Patent Literature 1: WO 2019/003846 A

### Non-Patent Literature

Non-Patent Literature 1: ACS APPLIED MATERIALS & INTERFACES, 2020, No. 12, PP. 3502-3509

### SUMMARY OF INVENTION

### Problems to be Solved by Invention

In order to achieve high capacity and high output of the all-solid-state NIB, a solid electrolyte having high Na ion conductivity is required. However, in a conventional oxide-based solid electrolyte, the ion conductivity is insufficient, and further improvement is required.

The present invention has been made in view of the above circumstances, and an object thereof is to provide a novel NASICON-based oxide exhibiting high Na ion conductivity and a method for producing the same. Further, an object of the present invention is to provide a solid electrolyte and a power storage device using the oxide.

### Solution to Problems

As a result of intensive studies to solve the above problems, the present inventors have found that in a NASICON [Na₃Zr₂Si₂PO₁₂]-based oxide, when a ratio of Si is increased and a specific element including Al is doped to a Zr site, excellent Na ion conductivity is exhibited, and have completed the present invention.

The present invention is as follows.
[1] An oxide satisfying the following formula (1).

Na_{3+2x+y+α}M1ₓM2_{y}M3_{z}Zr_{2-x-y-z}Si_{2+α}P_{1-α}O₁₂ (1)
(in the formula (1), M1 contains an element to be a divalent cation, M2 contains an element to be a trivalent cation containing Al, M3 contains an element (excluding Zr and Si) to be a tetravalent cation, and x, y, z, and a satisfy x≥0, 0<y<0.1, z≥0, and α>0)
[2] The oxide according to [1], in which α<1.0 is satisfied.
[3] The oxide according to [1] or [2], in which 0≤z≤0.3 is satisfied.
[4] A solid electrolyte including the oxide according to any one of [1] to [3].
[5] The solid electrolyte according to [4], in which a relative density of the solid electrolyte is 80% or more.
[6] A power storage device including the solid electrolyte according to [4] or [5].
[7] A method for producing the oxide according to any one of [1] to [3], the method including: a mixing step of mixing a plurality of supply components containing one or two or more elements of Na, the M1, the M2, the M3, Si, Zr, and P so as to satisfy the formula (1) to obtain a mixture of the supply components; and a firing step of firing the mixture to obtain the oxide.
[8] The method for producing the oxide according to [7], in which layered zirconium phosphate is used as the supply components of P and Zr.
[9] The method for producing the oxide according to [7] or [8], in which the mixing is wet mixing.
[10] The method for producing the oxide according to any one of [7] to [9], in which the firing step includes a step of firing at 900 °C or higher.

### Effects of Invention

According to the oxide of the present invention, high Na ion conductivity can be obtained in the NASICON-based oxide.

According to the solid electrolyte of the present invention, high Na ion conductivity can be obtained in the NASICON-based oxide.

According to the power storage device of the present invention, the NASICON-based oxide can be used as the solid electrolyte.

According to the method for producing the oxide of the present invention, the NASICON-based oxide having high Na ion conductivity can be obtained.

### BRIEF DESCRIPTION OF DRAWINGS

FIG. 1 is an explanatory view schematically illustrating an example (a) and another example (b) of an all-solid-state battery as a power storage device.

### DESCRIPTION OF EMBODIMENTS

Hereinafter, the present invention will be described in detail.

Note that unless otherwise specified, “%” means “mass %”, “parts” means “parts by mass”, “ppm” means “ppm by mass”, and “numerical value X to numerical value Y” means “numerical value X or more and numerical value Y or less”. Furthermore, embodiments described later can be an embodiment in which two or more embodiments are combined.

### [1] Oxide

The oxide of the present invention satisfies the following formula (1).

An oxide satisfying the following formula (1).

Na_{3+2x+y+α}M1ₓM2_{y}M3_{z}Zr_{2-x-y-z}Si_{2+α}P_{1-α}O₁₂ (1)
(in the formula (1), M1 contains an element to be a divalent cation, M2 contains an element to be a trivalent cation containing Al, M3 contains an element (excluding Zr and Si) to be a tetravalent cation, and x, y, z, and a satisfy x≥0, 0<y<0.1, z≥0, and α>0)

In Na₃Zr₂Si₂PO₁₂, P and Si form the same tetrahedral unit, and as an amount of Si in composition increases, an amount of P in the composition decreases by that amount.

That is, in the oxide having Na₃Zr₂Si₂PO₁₂ as a base (mother structure), it is essential that a part of Zr is substituted by M2 (including Al), and may be further substituted by M1 or M3, and it can be said that the oxide is an oxide in which the amount of Si in the composition is larger than that in the mother structure.

In the formula (1), x, y, z, and a satisfy x≥0, 0<y<0.1, z≥0, and α>0. That is, y and a are positive numbers.

M1 is an element to be a divalent cation. Examples of such an element include elements to be divalent cations among Group 2 elements, Group 12 elements, and transition elements (Group 3 to 11 elements), Sn, and Pd.

M2 contains Al. That is, an element to be a trivalent cation other than Al may be contained. Examples of such an element include elements to be trivalent cations among Group 3 elements, Group 13 elements, and the transition elements (Group 3 to 11 elements), Sb, and Bi. Note that the Group 13 element is preferably boron (B).

M3 may contain an element to be a tetravalent cation other than Zr and Si. Examples of such an element include elements (Te, Ce, and Th) to be tetravalent cations among Group 14 elements and transition elements (Group 3 to 11 transition elements).

In the formula (1), x, y, z, and a only needs to satisfy x≥0, 0<y<0.1, z≥0, and α>0 as described above, but further preferably satisfy x≤0.3, and more excellent Na ion conductivity can be obtained as compared with a case of x>0.3.

This is considered to be because segregation of M1 can be suppressed by satisfying x≤0.3. When content of M1 increases, solid solubility to a Zr site approaches a limit, an impurity phase containing a large amount of M1 starts to be formed, and the impurity phase inhibits Na ion conduction. Therefore, a composition in which the impurity phase is hardly formed is preferable, and from such a viewpoint, it is considered that a condition of x≤0.3 contributes. Note that the presence or absence of the segregation of M1 can be detected by distribution measurement of M1 using energy dispersive X-ray spectroscopy.

From the above viewpoint, it is considered that the condition of x≤0.3 contributes.

Here, as an upper limit of x, it is more preferable to satisfy x≤0.2, and still more preferable to satisfy x≤0.1. Further, as a lower limit of x, it is preferable to satisfy 0.01≤x, more preferable to satisfy 0.03≤x, and still more preferable to satisfy 0.05≤x.

Further, since M1 has a valence smaller than that of Zr, an electrostatic repulsive force with Na ion which is a monovalent cation is smaller than that of Zr. Therefore, it is considered that when Zr is substituted with M1, diffusion of Na ions near M1 is likely to occur.

Furthermore, it is preferable to satisfy y<0.1, and more excellent Na ion conductivity can be obtained as compared with a case of y≥0.1.

This is considered to be because the segregation of M2 can be suppressed by satisfying y<0.1. When the content of M2 increases, the solid solubility to the Zr site approaches the limit, the impurity phase containing a large amount of M2 starts to be formed, and the impurity phase inhibits Na ion conduction. Therefore, the composition in which the impurity phase is hardly formed is preferable, and from such a viewpoint, it is considered that a condition of y<0.1 contributes. Note that the presence or absence of the segregation of M2 can be detected by distribution measurement of M2 using the energy dispersive X-ray spectroscopy.

From the above viewpoint, it is considered that the condition of y<0.1 contributes.

Here, as an upper limit of y, it is more preferable to satisfy y≤0.09, still more preferable to satisfy y≤0.08, even still more preferable to satisfy y≤0.07, and yet even still more preferable to satisfy y≤0.06. Further, as a lower limit of y, it is preferable to satisfy 0.01≤y, more preferable to satisfy 0.02≤y, still more preferable to satisfy 0.03≤y, even still more preferable to satisfy 0.04≤y, and yet even still more preferable to satisfy 0.05≤y.

Further, since M2 has a valence smaller than that of Zr, the electrostatic repulsive force with Na ion which is the monovalent cation is smaller than that of Zr. Therefore, it is considered that when Zr is substituted with M2, diffusion of Na ions near M2 is likely to occur.

Furthermore, it is preferable to satisfy z≤0.3, and more excellent Na ion conductivity can be obtained as compared with a case of z>0.3.

This is considered to be because the segregation of M3 can be suppressed by satisfying z≤0.3. When the content of M3 increases, the solid solubility to the Zr site approaches the limit, the impurity phase containing a large amount of M3 starts to be formed, and the impurity phase inhibits Na ion conduction. Therefore, the composition in which the impurity phase is hardly formed is preferable, and from such a viewpoint, it is considered that a condition of z≤0.3 contributes. Note that the presence or absence of the segregation of M3 can be detected by distribution measurement of M3 using the energy dispersive X-ray spectroscopy.

From the above viewpoint, it is considered that the condition of z≤0.3 contributes.

Here, as an upper limit of z, it is more preferable to satisfy z≤0.2, and still more preferable to satisfy z≤0.1. Further, as the lower limit of z, it is preferable to satisfy z≥0.01, more preferable to satisfy z≥0.03, and still more preferable to satisfy z≥0.05.

Furthermore, it is preferable to satisfy α<1.0, and more excellent Na ion conductivity can be obtained as compared with a case of α=1.0.

Further, since Si has a valence smaller than that of P, the electrostatic repulsive force with Na ion which is the monovalent cation is smaller than that of P. Therefore, it is considered that when P is substituted with Si, diffusion of Na ions near Si is likely to occur.

On the other hand, when the Si substitution amount increases, an effect of inhibiting Na ion conduction due to Na ions being trapped near Si is remarkable. Therefore, it is considered that the ion conductivity is deteriorated when the Si substitution amount is large. From such a viewpoint, it is considered that the condition α<1.0 contributes.

Here, as an upper limit of α, it is more preferable to satisfy α≤0.9, still more preferable to satisfy α≤0.8, still more preferable to satisfy α≤0.7, even still more preferable to satisfy α≤0.6, and yet even still more preferable to satisfy α≤0.5. Further, as a lower limit of u, it is preferable to satisfy α≥0.1, more preferable to satisfy α≥0.15, still more preferable to satisfy α≥0.2, even still more preferable to satisfy α≥0.25, and yet even still more preferable to satisfy α≥0.3.

Note that in the oxide represented by the formula (1), a stoichiometric ratio of O is described as 12, but in practice, the stoichiometric ratio of O may be less than 12 or may be more than 12 as long as neutrality of charge of the oxide as a whole can be maintained.

For example, when the formula (1) is expressed as formula (2) as follows (M1, M2, M3, x, y, z, and α are the same as in the formula (1)),

Na_{3+2x+y+α}M1ₓM2_{y}M3_{z}Zr_{2-x-y-z}Si_{2+α}P_{1-α}O_{12+β} (2)
β can be, for example, 0≤β<1.

Further, in the oxide of the present invention, a phase structure is not limited, and as a result, an oxide having high Na ion conductivity is preferable. Among them, it is preferable to exhibit an Na Super Ionic Conductor (NASICON) type. This is because NASICON type is superior in use as a solid electrolyte. That is, unlike a layered structure or the like, the NASICON type is useful as a solid electrolyte with a high operating voltage because a movement space of Na ions is three-dimensionally expanded, and zirconium is stable even under a high voltage.

Note that whether or not the oxide of the present invention exhibits the NASICON type can be determined from a diffraction profile obtained by powder X-ray diffraction measurement.

A relative density of the oxide of the present invention is preferably 80% or more, more preferably 85% or more, still more preferably 90% or more, and even still more preferably 95% or more in that more excellent Na ion conductivity can be obtained.

Here, the relative density can be obtained by measuring diameter, thickness, and mass of the solid electrolyte, calculating an actual measured density from actual measured values of volume and mass, and then calculating a ratio (%) of the actual measured density to a theoretical density.

Use of the oxide of the present invention is not particularly limited, but for example, the oxide can be used as a material for a power storage device (a material for an all-solid-state battery and various secondary battery materials), a CO₂ sensor, or the like.

Specific examples thereof include a solid electrolyte (solid electrolyte material) of the all-solid-state battery, an electrode (electrode material) of the all-solid-state battery, and a separator.

### [2] Method for Producing Oxide

The oxide described above may be produced in any manner, may be produced using a solid phase method, or may be produced using a liquid phase method, but in the present invention, it can be produced using the solid phase method. More specifically, it can be produced by including a mixing step and a firing step.

Among the above, the mixing step is a step of mixing a plurality of supply components containing one or two or more elements of Na, the M1, the M2, the M3, Zr, Si, and P so as to satisfy the formula (1) to obtain a mixture of the supply components.

Further, among the above, the firing step is a step of firing the mixture to obtain the oxide.

In the present method, the supply component that supplies each element of Na, the M1, the M2, the M3, Zr, Si, and P may be an inorganic compound or an organic compound.

For example, carbonates, hydrogen carbonates, sulfates, sulfites, nitrates, nitrites, phosphates, acetates, citrates, ammonium salts, oxides, hydroxides, chlorides, sulfides, and the like of these metal elements can be used. Note that these supply components may be compounds in which one kind of supply component contains two or more kinds of elements of Na, M1, M2, M3, Zr, Si, and P.

Further, in the mixing step described above, a plurality of supply components containing one or two or more elements of Na, M1, M2, M3, Zr, Si, and P is weighed so as to satisfy the formula (1), that is, so as to satisfy a stoichiometric ratio of the composition represented by the formula (1), and then weighed materials are mixed.

Mixing may be performed by dry mixing, but it is preferable to perform wet mixing using a liquid. By performing the wet mixing, a density of a sintered body after firing can be increased as compared with a case of performing the dry mixing, and the Na ion conductivity can also be relatively improved. As the liquid used for the wet mixing, water, various organic solvents, mixtures thereof, and the like can be appropriately used.

In the firing step, the mixture obtained in the mixing step may be fired without being molded, or may be fired after being molded.

Firing temperature is not limited, and can be, for example, 900 °C or higher, and is preferably 1,000 °C or higher, more preferably 1,100 °C or higher, still more preferably 1,150 °C or higher, even still more preferably 1,200 °C or higher, and yet even still more preferably 1,250 °C or higher. Further, the temperature can be, for example, 1,600 °C or lower, and is preferably 1,500 °C or lower, more preferably 1,400 °C or lower, still more preferably 1,350 °C or lower, and even still more preferably 1,300 °C or lower.

Furthermore, the firing may be performed in one stage, or may be performed in a plurality of stages via pre-firing. That is, the temperature can be increased stepwise from a temperature lower than the firing temperature to finally impose a temperature necessary for firing. Further, each pre-firing can be performed through a pulverization step of pulverizing an obtained pre-fired product.

When the pre-firing is performed in a plurality of stages, for example, the firing may be performed in two stages of performing first pre-firing at 1,000 °C or higher and lower than 1,150 °C and performing main firing at 1,150 °C or higher, in three stages of performing first pre-firing in a temperature range of 400 °C or higher and lower than 800 °C, performing second pre-firing in a temperature range of 800 °C or higher and lower than 1,200 °C, and performing main firing in a temperature range of 1,200 °C or higher, or in four or more stages.

Further, although a firing time is not limited, for example, the pre-firing can be performed for 1 hour or more and 40 hours or less, and the main firing can be performed for 1 hour or more and 40 hours or less.

### [3] Solid Electrolyte

The solid electrolyte of the present invention contains the oxide described above.

An amount of the oxide contained in the solid electrolyte is not limited, and can be, for example, 0<X (mass %)≤100 in which X mass % is content of the oxide when the entire solid electrolyte is 100 mass %. Further, the amount can be, for example, 50≤X (mass %)≤100, and 75≤X (mass %)≤100.

The solid electrolyte of the present invention can contain another oxide which has Na ion conductivity but is not represented by the formula (1). Examples of other solid electrolytes include an oxide having Na ion conductivity satisfying the following formula (3), an oxide having Na ion conductivity satisfying the following formula (4), an oxide having Na ion conductivity satisfying the following formula (5), an oxide having Na ion conductivity satisfying the following formula (6), an oxide having Na ion conductivity satisfying the following formula (7), and an oxide having Na ion conductivity satisfying the following formula (8). These may be used alone or in combination of two or more.

Na_{1+2x+y}M1ₓM2_{y}Zr_{2-x-y}P₃O₁₂ (3)
(in the formula (3), M1 is a divalent element, M2 is a trivalent element, and x and y satisfy x≥0 and y≥0)

Na_{1+α}Zr₂Si_{α}P_{3-α}O₁₂ (4)
(in the formula (4), α>0 is satisfied)

Na_{1+2x+y+α}M1ₓM2_{y}Zr_{2-x-y}M4_{α}P_{3-α}O₁₂ (5)
(in the formula (5), M1 is a divalent element, M2 is a trivalent element, M4 is a tetravalent element, and x, y, and a satisfy x≥0, y≥0, α>0, and x+y>0)

Na_{1+2x+y}M1ₓM2_{y}M3_{z}Zr_{2-x-y-z}P₃O₁₂ (6)
(in the formula (1), M1 is a divalent element, M2 is a trivalent element, M3 is a tetravalent element, and x, y, and z satisfy x≥0, y≥0, and z≥0)

Na_{1+2x+y+α}M1ₓM2_{y}M3_{z}Zr_{2-x-y-z}Si_{α}P_{3-α}O₁₂ (7)
(in the formula (1), M1 is a divalent element, M2 is a trivalent element, M3 is a tetravalent element, and x, y, z, and a satisfy x≥0, y≥0, z>0, and α>0)

Na_{1+2x+y-γ+α}M1ₓM2_{y}M3_{z}M5_{γ}Zr_{2-x-y-z-γ}Si_{α}P_{3-α}O₁₂ (8)
(in the formula (1), M1 is a divalent element, M2 is a trivalent element, M3 is a tetravalent element, M5 is a pentavalent element, and x, y, z, y, and α satisfy x≥0, y≥0, z>0, γ≥0, and α>0)

Note that a divalent nonmetal element and a divalent metal element can be applied to M1 in the formulas (3), (5), (6), (7), and (8). Further, a trivalent nonmetal element and a trivalent metal element can be applied to M2. Further, a tetravalent nonmetal element and a tetravalent metal element can be applied to M4 in the formula (5). Further, a tetravalent nonmetal element and a tetravalent metal element can be applied to M3 in the formulas (6), (7), and (8). Furthermore, a pentavalent nonmetal element and a pentavalent metal element can be applied to M5 in the formula (8).

### [4] All-Solid-State Battery

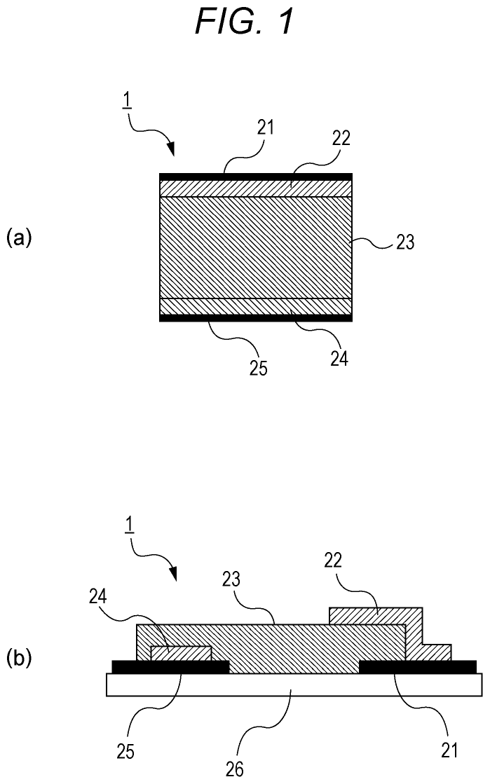

An all-solid-state battery 1 of the present invention includes the above-described solid electrolyte 23 (solid electrolyte layer) (see FIG. 1).

Usually, the all-solid-state battery 1 includes a positive electrode 22 (positive electrode layer) and a negative electrode 24 (negative electrode layer) in addition to the solid electrolyte 23. The all-solid-state battery may be a bulk type (see FIG. 1(a)) or a thin film type (see FIG. 1(b)).

When the all-solid-state battery 1 is a bulk type (see FIG. 1(a)), the positive electrode 22 and the negative electrode 24 can be arranged to face each other with the solid electrolyte 23 interposed therebetween. Further, the positive electrode 22 and the negative electrode 24 are each disposed in contact with the solid electrolyte 23. For example, the all-solid-state battery 1 can include the solid electrolyte 23, the positive electrode 22, and the negative electrode 24 as an integrated fired body. More specifically, when the solid electrolyte 23 (solid electrolyte layer) has a property of having two main surfaces, that is, when the solid electrolyte layer is a plate-like body, a membrane-like body, a sheet, a film, or the like, there can be provided a structure including the positive electrode 22 on one main surface and the negative electrode 24 on the other main surface with the solid electrolyte 23 interposed therebetween.

The positive electrode usually contains a positive electrode active material, and can additionally contain, for example, one or more of a conductive material, a solid electrolyte, a binder, and the like.

Similarly, the negative electrode also usually contains a negative electrode active material, and can additionally contain, for example, one or more of the conductive material, the solid electrolyte, the binder, and the like.

Further, each electrode can include a current collector. That is, the positive electrode 22 can include a positive electrode current collector 21 on a surface on a side not in contact with the solid electrolyte 23. Similarly, the negative electrode 24 can include a negative electrode current collector 25 on a surface on a side not in contact with the solid electrolyte 23.

When the all-solid-state battery 1 is a thin film type (see FIG. 1(b)), the positive electrode 22 and the negative electrode 24 can be arranged apart from each other such that a portion of each is in contact with the solid electrolyte 23. For example, the all-solid-state battery 1 can be provided as an integrated fired body in which the negative electrode 24, the solid electrolyte 23, and the positive electrode 22 are laminated in this order.

Even when the all-solid-state battery 1 is a thin film type, similarly to a bulk type, the positive electrode usually contains the positive electrode active material, and can additionally contain, for example, one or two or more of the conductive material, the solid electrolyte, the binder, and the like, and the negative electrode also usually contains the negative electrode active material, and can additionally contain, for example, one or two or more of the conductive material, the solid electrolyte, the binder, and the like. Further, each electrode can include a current collector.

### EXAMPLES

### <<Production of Oxide>>

### (1) Example 1

3.097 g of sodium carbonate (manufactured by FUJIFILM Wako Pure Chemical Corporation), 0.010 g of aluminum oxide (manufactured by FUJIFILM Wako Pure Chemical Corporation), 4.608 g of zirconium oxide (manufactured by FUJIFILM Wako Pure Chemical Corporation), 2.371 g of silicon dioxide, and 1.945 g of ammonium dihydrogen phosphate (manufactured by FUJIFILM Wako Pure Chemical Corporation) as supply components were weighed so as to have a molar ratio (Na:Al:Zr:Si:P=3.11:0.01:1.99:2.10:0.90) shown in Example 1 in Table 1, and each sample was put into a mortar, and 20 g of pure water was added thereto for wet mixing to obtain a mixture.

The obtained mixture was dried at 100 °C for 3 hours and then transferred to an alumina crucible (volume: 30 mL), and the temperature was raised to 1,100 °C over 5.5 hours and held for 5 hours to perform first pre-firing. Thereafter, the mixture was allowed to cool to room temperature to obtain a first pre-fired product.

The obtained first pre-fired product was pulverized with a planetary ball mill in an ethanol dispersion medium for 1 hour using φ5 mm ZrO₂ balls. Thereafter, it was passed through a 330 mesh sieve, and the obtained dispersion was dried at 80 °C.

0.3 g of the pulverized product of the obtained first pre-fired product was placed in a mold having a diameter of 1.2 cm, and molded into a coin shape by applying a load of 1 t with a hydraulic press. The obtained molded product was placed on a platinum plate, heated to 800 °C over 30 minutes, further heated to a main firing temperature (1,200 °C) described in Example 1 in Table 1 over 2 hours, and held for 4 hours to perform main firing. Thereafter, the product was allowed to cool to room temperature to obtain an oxide of Example 1.

### (2) Examples 2 to 17 and Comparative Examples 1 to 3

In the same manner as in Example 1, predetermined samples were weighed so as to have molar ratios shown in Example 2 to 17 and Comparative Example 1 to 3 in Table 1, and each sample was put in a mortar, 20 g of pure water was added thereto for wet mixing to obtain a mixture. The obtained mixture was subjected to the pre-firing and the main firing under the same conditions as in Example 1 to obtain an oxide of each of Example 2 to 17 and Comparative Example 1 to 3.

Note that in Examples 11 to 14, the first pre-fired product was molded into a coin shape in the same manner as in Example 1, then the obtained molded product was placed on a platinum plate, heated to 800 °C over 30 minutes, further heated to the main firing temperature described in Example 11 to 14 in Table 1 over 2 hours, and held for 4 hours to perform main firing. Thereafter, the mixture was allowed to cool to room temperature to obtain each oxide of Examples 11 to 14.

In Examples 15 and 17, titanium oxide (manufactured by FUJIFILM Wako Pure Chemical Corporation) was used as a raw material of Ti.

In Examples 16 and 17, magnesium oxide (manufactured by FUJIFILM Wako Pure Chemical Corporation) was used as a raw material of Mg.

### (3) Example 18

3.147 g of sodium carbonate (manufactured by FUJIFILM Wako Pure Chemical Corporation), 0.048 g of aluminum oxide (manufactured by FUJIFILM Wako Pure Chemical Corporation), 2.378 g of silicon dioxide, 2.555 g of layered zirconium phosphate (Zr(HPO₄)₂·nH₂O), and 4.173 g of zirconium oxide as supply components were weighed so as to have a molar ratio (Na:Al:Zr:Si:P=3.15:0.05:1.95:2.10:0.90) shown in Example 18 in Table 1, and each sample was put into a mortar, and 20 g of pure water was added thereto for wet mixing to obtain a mixture. The obtained mixture was used to obtain an oxide of Example 18 in the same manner as in Example 1. In Examples of the present specification, a value of n in Zr(HPO₄)₂·nH₂O is n=1.0.

### <<Description of Evaluation Method>>

### (1) Measurement of Relative Density

The relative densities of the oxides of Examples 1 to 18 and Comparative Examples 1 to 3 were calculated, and the results are shown in Table 1. A calculation method is as follows.

The diameter, thickness, and mass of the oxide produced above were measured, and the actual measured density was calculated from the actual measured values of the volume and mass. Then, the relative density was calculated by calculating the ratio (%) of the actual measured density to the theoretical density.

### (2) Identification of Crystal Phase

Identification of a main crystal phase of each of the oxides of Example 1 to 18 and Comparative Example 1 to 3 was performed using X-ray diffraction (XRD) measurement. XRD measurement conditions are as follows.
X-ray diffractometer: D8 ADVANCE manufactured by Bruker AXS
Characteristic X-ray: CuKα
Measurement voltage: 40 kV
Measurement current: 40 mA
Measurement method: continuous
Measurement range: 10°≤2θ≤80°
Step side: 0.01°
Scan speed: 2.5°/min

In all the oxides of Examples 1 to 18 and Comparative Examples 1 to 3, the main crystal phase was attributed to monoclinic or rhombohedral Na₃Zr₂Si₂PO₁₂, and it was confirmed that all of them had a NASICON-type crystal structure.

### (3) Evaluation of Ion Conductivity

### (3-1) Formation of Current Collector Layer

Each of the oxides (coin-shaped sintered pellets) obtained in Examples 1 to 18 and Comparative Examples 1 to 3 was masked with a polyimide tape such that a circular exposed surface having a diameter of 6 mm was formed at a center of each of both surfaces of the oxides. Thereafter, a current collector layer was formed on the exposed surface by sputtering. The current collector layer was formed as a gold (Au) layer having a thickness of about 50 nm. A gold vapor deposition apparatus (Ion coater IB-2/IB-3 manufactured by Eiko Co., Ltd.) was used for sputtering.

### (3-2) Measurement of AC Impedance

In the above (3-1), AC impedance of each oxide of Examples 1 to 18 and Comparative Examples 1 to 3 in which the current collector layer was formed was measured, and a complex impedance plot was created. In Examples 1 to 18 and Comparative Examples 1 to 3, measurement was performed at a frequency of 20 Hz to 120 MHz and a voltage of 10 mV using an impedance analyzer (Model “E4990A” manufactured by Keysight Technologies, Inc.).

### (3-3) Calculation of Ion Conductivity

A value of a terminal at a right end of an arc in the complex impedance plot obtained in the above (3-2) was defined as a resistance R (sum of a bulk resistance and a grain boundary resistance) of each oxide, and an ion conductivity σ (Na ion conductivity) was calculated using the following formula. The results are shown in Table 1.

σ=(t/A)×(1/R)
σ: Ion conductivity
t: Thickness of sample
A: Area of electrode
R: Resistance of oxide

### (3-4) Calculation of Bulk Ion Conductivity

In an example in which waveforms of two arcs were observed in the complex impedance plots of Examples 1 to 18 and Comparative Examples 1 to 3 obtained in the above (3-2), a diameter of a first arc was set as the bulk resistance (Rb), and a bulk ion conductivity Gb (bulk Na ion conductivity) was calculated using the following formula. The results are shown below and also shown in Table 1.

σb=(t/A)×(1/Rb)
σb: Ion conductivity
t: Thickness of sample
A: Area of electrode
Rb: bulk resistance

TABLE 1

| | | Oxide | | | | | | | | | Evaluation results | |
|---|---|---|---|---|---|---|---|---|---|---|---|---|
| | | [Na] | | | | [Zr] | | | Main firing | | Na ion | Bulk Na ion |
| | | 3 + 2x + | [Mg] | [Al] | [Ti] | 2 − x − | [Si] | [P] | temperature | Relative | conductivity | conductivity |
| | | y + α | x | y | z | y − z | 2 + α | 1 − α | (°C) | density | (S/cm) | (S/cm) |
| Examples | 1 | 3.11 | 0.00 | 0.01 | 0.00 | 1.99 | 2.10 | 0.90 | 1200 | 91 | 9.8.E−04 | 2.0.E−03 |
| | 2 | 3.13 | 0.00 | 0.03 | 0.00 | 1.97 | 2.10 | 0.90 | 1200 | 91 | 1.8.E−03 | 3.9.E−03 |
| | 3 | 3.15 | 0.00 | 0.05 | 0.00 | 1.95 | 2.10 | 0.90 | 1200 | 92 | 2.5.E−03 | 4.7.E−03 |
| | 4 | 3.17 | 0.00 | 0.07 | 0.00 | 1.93 | 2.10 | 0.90 | 1200 | 93 | 2.1.E−03 | 4.5.E−03 |
| | 5 | 3.19 | 0.00 | 0.09 | 0.00 | 1.91 | 2.10 | 0.90 | 1200 | 90 | 1.7.E−03 | 4.3.E−03 |
| | 6 | 3.10 | 0.00 | 0.05 | 0.00 | 1.95 | 2.05 | 0.95 | 1200 | 93 | 1.5.E−03 | 3.6.E−03 |
| | 7 | 3.25 | 0.00 | 0.05 | 0.00 | 1.95 | 2.20 | 0.80 | 1200 | 93 | 3.4.E−03 | 5.6.E−03 |
| | 8 | 3.45 | 0.00 | 0.05 | 0.00 | 1.95 | 2.40 | 0.60 | 1200 | 91 | 4.6.E−03 | 9.2.E−03 |
| | 9 | 3.65 | 0.00 | 0.05 | 0.00 | 1.95 | 2.60 | 0.40 | 1200 | 88 | 2.0.E−03 | 3.5.E−03 |
| | 10 | 3.75 | 0.00 | 0.05 | 0.00 | 1.95 | 2.70 | 0.30 | 1200 | 85 | 9.2.E−04 | 1.0.E−03 |
| | 11 | 3.15 | 0.00 | 0.05 | 0.00 | 1.95 | 2.10 | 0.90 | 1150 | 83 | 8.9.E−04 | 3.6.E−03 |
| | 12 | 3.15 | 0.00 | 0.05 | 0.00 | 1.95 | 2.10 | 0.90 | 1300 | 95 | 4.0.E−03 | 7.4.E−03 |
| | 13 | 3.15 | 0.00 | 0.05 | 0.00 | 1.95 | 2.10 | 0.90 | 1350 | 93 | 2.0.E−03 | 4.7.E−03 |
| | 14 | 3.45 | 0.00 | 0.05 | 0.00 | 1.95 | 2.40 | 0.60 | 1300 | 95 | 6.5.E−03 | 1.3.E−02 |
| | 15 | 3.15 | 0.00 | 0.05 | 0.05 | 1.90 | 2.10 | 0.90 | 1200 | 94 | 3.1.E−03 | 5.2.E−03 |
| | 16 | 3.25 | 0.05 | 0.05 | 0.00 | 1.90 | 2.10 | 0.90 | 1200 | 92 | 2.7.E−03 | 4.4.E−03 |
| | 17 | 3.25 | 0.05 | 0.05 | 0.05 | 1.85 | 2.10 | 0.90 | 1200 | 91 | 2.8.E−03 | 5.3.E−03 |
| | 18 | 3.15 | 0.00 | 0.05 | 0.00 | 1.95 | 2.10 | 0.90 | 1200 | 93 | 2.8.E−03 | 4.9.E−03 |
| Comparative | 1 | 3.00 | 0.00 | 0.00 | 0.00 | 2.00 | 2.00 | 1.00 | 1200 | 80 | 4.8.E−04 | 7.5.E−04 |
| Examples | 2 | 3.10 | 0.00 | 0.00 | 0.00 | 2.00 | 2.10 | 0.90 | 1200 | 77 | 8.0.E−04 | 1.0.E−03 |
| | 3 | 3.00 | 0.00 | 0.05 | 0.00 | 1.95 | 2.00 | 1.00 | 1200 | 88 | 4.7.E−04 | 8.7.E−04 |

### <<Evaluation Results>>

As is apparent from the results of Examples 1 to 18, the oxide of the present invention was excellent in Na ion conductivity.

In the case of doping with Al (Examples 1 to 5), the Na ion conductivity was more excellent as Al substitution ratio y approached 0.05.

Further, when the Si substitution amount was increased (Examples 3 and 6 to 10), the Na ion conductivity was maximized when Si substitution ratio α was 0.40 (Example 8).

Furthermore, when attention was paid to the main firing temperature (Examples 3 and 11 to 13), the Na ion conductivity was most excellent in the firing at 1,300 °C.

In contrast, the Na ion conductivity of each oxide in cases of no doping (Comparative Example 1), only an increase in the amount of Si (Comparative Example 2), and only Al doping (Comparative Example 3) was lower than that in Examples 1 to 18, resulting in poor practicality.

From the above results, it was found that higher Na ion conductivity is exhibited by doping Al and increasing the amount of Si.

### LIST OF REFERENCE SIGNS

1 All-solid-state battery
21 Current collector (positive electrode current collector)
22 Positive electrode
23 Solid electrolyte
24 Negative electrode
25 Current collector (negative electrode current collector)
26 Substrate

1. An oxide satisfying the following formula (1):
Na_{3+2x+y+α}M1ₓM2_{y}M3_{z}Zr_{2-x-y-z}Si_{2+α}P_{1-α}O₁₂ (1)
(in the formula (1), M1 contains an element to be a divalent cation, M2 contains an element to be a trivalent cation containing Al, M3 contains an element (excluding Zr and Si) to be a tetravalent cation, and x, y, z, and α satisfy x≥0, 0<y<0.1, z≥0, and α>0).

2. The oxide according to claim 1, wherein α<1.0 is satisfied.

3. The oxide according to claim 1, wherein 0≤z≤0.3 is satisfied.

4. A solid electrolyte comprising the oxide according to claim 1.

5. The solid electrolyte according to claim 4, wherein a relative density of the solid electrolyte is 80% or more.

6. A power storage device comprising the solid electrolyte according to claim 5.

7. A method for producing the oxide according to claim 1, the method comprising:
a mixing step of mixing a plurality of supply components containing one or two or more elements of Na, the M1, the M2, the M3, Si, Zr, and P so as to satisfy the formula (1) to obtain a mixture of the supply components; and
a firing step of firing the mixture to obtain the oxide.

8. The method for producing the oxide according to claim 7, wherein layered zirconium phosphate is used as the supply components of P and Zr.

9. The method for producing the oxide according to claim 7, wherein the mixing is wet mixing.

10. The method for producing the oxide according to claim 7, wherein the firing step includes a step of firing at 900 °C or higher.

11. A solid electrolyte comprising the oxide according to claim 2.

12. A solid electrolyte comprising the oxide according to claim 3.

13. The solid electrolyte according to claim 11, wherein a relative density of the solid electrolyte is 80% or more.

14. The solid electrolyte according to claim 12, wherein a relative density of the solid electrolyte is 80% or more.

15. A power storage device comprising the solid electrolyte according to claim 13.

16. A power storage device comprising the solid electrolyte according to claim 14.

17. The method for producing the oxide according to claim 8, wherein the firing step includes a step of firing at 900 °C or higher.

18. The method for producing the oxide according to claim 9, wherein the firing step includes a step of firing at 900 °C or higher.
